(19) United States
(12) Patent Application Publication
(10) Pub. No.: US 2026/0010716 A1
(43) Pub. Date: Jan. 8, 2026

(54) TECHNIQUES FOR IMPROVING DATA RELIABILITY OF DIGITIZED TEXT USING CERTAINTY ALGORITHMS

(71) Applicant: Optum, Inc., Minnetonka, MN (US)

(72) Inventors: Kapil Mohan, Bangalore (IN); Alankrit Kumar Bhaskar, Agra (IN); Shruti Raj, Bengaluru (IN)

(21) Appl. No.: 19/005,307

(22) Filed: Dec. 30, 2024

Related U.S. Application Data
(60) Provisional application No. 63/666,860, filed on Jul. 2, 2024.

(51) Int. Cl. G06F 40/242

(52) U.S. Cl. CPC G06F 40/242

(57) ABSTRACT

Techniques for improving the reliability of digitized text may comprise receiving data corresponding to a data extraction program. The techniques may further comprise executing a confidence algorithm to generate a dictionary of words from fields in a file, determine, based at least in part on a confidence score from the dictionary of words, a content confidence score corresponding to a first field of the file, and determine, based on the content confidence score and a position confidence score, a certainty score for the first field. The techniques may further comprise determining, based at least in part on the certainty score, a certainty quotient for the file indicating a reliability of the data corresponding to the data extraction program, and generating a data object that indicates the certainty quotient. These techniques generate reliable indications of the accuracy of digitized text extracted from a file and substantially reduce false positives/negatives.

### CROSS-REFERENCE TO RELATED APPLICATION

This application claims priority to U.S. Provisional Patent Application No. 63/666,860, entitled “Techniques for Digitizing Handwritten Text Using a Certainty Score,” filed on Jul. 2, 2024, the disclosure of which is hereby incorporated herein by reference.

### TECHNICAL FIELD

The present disclosure generally relates to certainty algorithms and models configured to improve the reliability of digitized text through word and positional confidence score determinations.

### BACKGROUND

Techniques for recognizing and extracting/reproducing text from handwritten or printed documents suffer from notable drawbacks. For example, existing text recognition systems typically provide a measure of confidence in their output, known as a confidence score, intended to indicate the reliability of the system's predictions. However, in practice, these confidence scores are challenging to accurately leverage, as existing systems often compare the confidence scores against arbitrarily defined thresholds. These thresholds are frequently too high or too low to prevent significant numbers of false positives (e.g., text indicated as accurate that is inaccurately recognized) and/or false negatives (e.g., text indicated as inaccurate that is accurately recognized). Existing techniques are thus unable to accurately gauge the reliability of extracted data, resulting in substantial volumes of inaccurately recognized/extracted text data in outputs of such existing techniques.

### BRIEF DESCRIPTION OF THE DRAWINGS

The figures described below depict embodiments for purposes of illustration only. One skilled in the art will readily recognize from the following discussion that alternative embodiments of the systems and methods illustrated herein may be employed without departing from the principles of the disclosure described herein. The detailed description is described with reference to the accompanying figures. In the figures, the same reference number appearing in different figures indicates a same or similar item.

FIG. 1 depicts an example computing system in which various embodiments of the present disclosure may be implemented.

FIG. 2 depicts an example computer-implemented confidence score determination process, in accordance with various embodiments described herein.

FIG. 3 depicts an example computer-implemented content confidence score determination process, in accordance with various embodiments described herein.

FIG. 4 depicts an example computer-implemented relationship determination process, in accordance with various embodiments described herein.

FIG. 5 depicts an example computer-implemented certainty quotient and data object determination process, in accordance with various embodiments described herein.

FIG. 6 depicts a flow diagram representing an example computer-implemented method, in accordance with various embodiments described herein.

### DETAILED DESCRIPTION

Broadly speaking, the techniques of the present disclosure determine reliability indicators for extracted/recognized data (e.g., text, such as handwritten text). More specifically, the techniques of the present disclosure may leverage a confidence algorithm to generate confidence scores for content (e.g., words) and positions (e.g., of fields) of extracted data to determine certainty scores that indicate the reliability of data included in a particular field. The techniques of the present disclosure may then determine a certainty quotient corresponding to entire files/documents based on the certainty scores associated with the files/documents. The techniques of the present disclosure improve upon conventional data recognition/extraction techniques at least by generating more accurate/reliable outputs than such conventional techniques.

As referenced herein, a “field” may generally represent a particular set of information or data that is extracted from a file/document (referenced herein as a “file”) and may include one or more words. Fields may generally be identified based on their semantic meaning and relevance to the file. For example, a field may represent an extracted value of an individual's name, address, or date of birth from an identification file.

As mentioned, many existing techniques rely on confidence scores provided by application programming interfaces (APIs) to determine the accuracy of extracted text. These confidence scores, typically represented as a number between 0 and 1, attempt to quantify the certainty of the extraction/recognition model regarding the accuracy of the extracted text. This confidence score is then typically compared to arbitrarily defined thresholds, resulting in substantially elevated rates of false positives and false negatives.

By contrast, the present techniques overcome these challenges faced by existing solutions through the determination and use of a certainty score and certainty quotient based on content and position confidence scores of data within a file. More specifically, the present techniques utilize multiple confidence scores (e.g., content and positional confidence scores) to determine a certainty score that may generally represent the confidence in digitization of particular words within a field and the position of that field within the file and may be included as part of the metadata output by an API associated with the data extraction program. The positional confidence score may generally indicate the level of certainty regarding the location of a field within a file (e.g., on a page of a document). The content confidence score may generally indicate the level of confidence in the correct digitization of the word(s) or content within the field. The present techniques may determine this content confidence score based in part on a generated dictionary of words that indicates, at least in part, the words (and associated word confidence values) included in the field.

Using this certainty score, the present techniques may determine a certainty quotient, which may generally be a combined certainty score that may indicate the reliability of the file data based on the relative importance of up to each field within the file. The present techniques thereby dynamically determine the reliability of data extracted from a file using contextual information directly from the file (e.g., dictionary of words), instead of arbitrarily defined scores/thresholds, and consequently reduce/eliminate false positives/negatives, as compared to existing techniques. At least for this reason, the present techniques improve upon such existing techniques and improve the functioning of a computer or computing device by more accurately determining the reliability of extracted data than existing techniques are capable of achieving.

Additionally, the present techniques generate features for a field using the content and position confidence scores to serve as inputs into a certainty model, which determines the certainty score for the field. By normalizing these features (e.g., to a range of 0 to 1), the present techniques ensure that no single feature disproportionately influences the certainty model (e.g., dominates the model's decision-making process) due to scale differences. This normalization thereby enables the certainty model to accurately segregate and interpret the data, leading to the model determining certainty scores that more reliably indicate potential errors in the extracted data than was possible using existing techniques. In particular, using such normalized features as inputs for the certainty model enhances the reliability of the extracted data at a field level, which existing techniques are generally incapable of providing, such that the present techniques provide more granular reliability data than existing techniques.

The techniques of the present disclosure thus improve the functionality of a computing device (e.g., a hosting server such as a central server) at least by analyzing extracted data in a particular way to enhance the reliability of the extracted data. The confidence algorithm, executing on the computing device, determines confidence scores and certainty scores to determine reliable certainty quotients that were not determined as part of conventional techniques. That is, the present disclosure describes improvements in the functioning of the computer itself because the computing device more accurately indicates the reliability of extracted data as a direct result of the confidence algorithm. This is an improvement over other techniques at least because existing systems typically lack a reliable indication of the accuracy of extracted data and/or are otherwise unable to indicate extracted data accuracy with the reliability resulting from the confidence algorithm.

Still further, the present disclosure includes specific features other than what is well-understood, routine, conventional activity in the field, or adding unconventional steps that demonstrate, in various embodiments, particular useful applications, e.g., executing, by the one or more processors, a confidence algorithm that causes the one or more processors to perform operations comprising: generating a dictionary of words from one or more fields in the first file, wherein an entry in the dictionary of words corresponding to a first word in a first field of the first file includes a first confidence score associated with the first word, determining, based at least in part on the first confidence score from the entry in the dictionary of words, a content confidence score corresponding to the first field, and determining, based on the content confidence score and a position confidence score, a certainty score for the first field, the position confidence score being associated with a position of the first field within the first file; and/or determining, by the one or more processors based at least in part on the certainty score, a certainty quotient for the first file indicating a reliability of the data corresponding to the data extraction program, among others.

Of course, it should be appreciated that the advantages and technical improvements described above and elsewhere herein are not the only advantages and/or technical improvements that may be realized as a result of the techniques described herein. Other advantages and/or technical improvements to the functioning of a computer itself or other technologies or technical fields may be apparent to one of ordinary skill in the art. Moreover, while described herein primarily in the health care context, the techniques described herein may be readily applied in any suitable field for any suitable purpose.

### Example Computing System

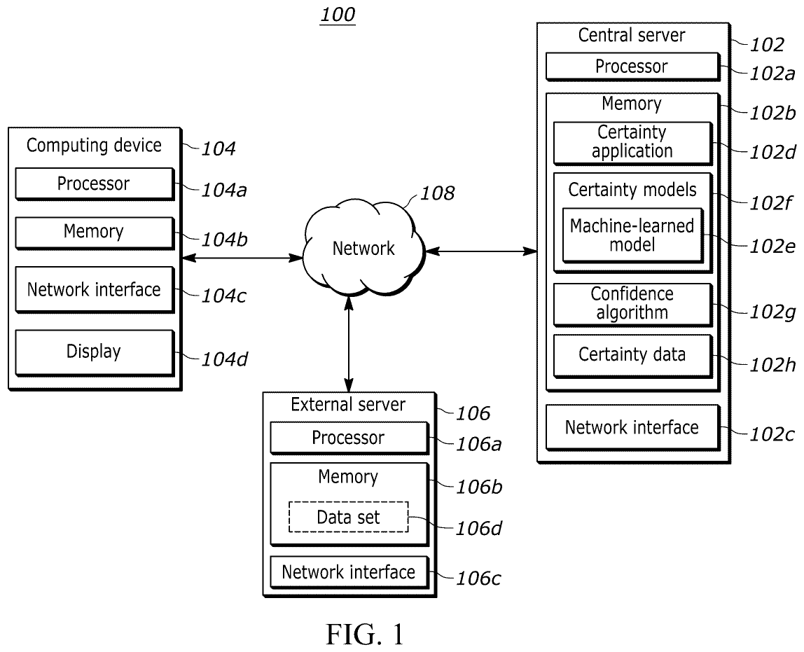

FIG. 1 depicts an example computing system 100 in which various embodiments of the present disclosure may be implemented. Depending on the embodiment, the example computing system 100 may determine confidence scores, generate normalized features, determine certainty scores, determine certainty quotients, and/or perform actions associated with any related values or combinations thereof. Of course, it should be appreciated that, while the various components of the example computing system 100 (e.g., central server 102, computing device 104, external server 106) are illustrated in FIG. 1 as single components, the example computing system 100 may include multiple (e.g., dozens, hundreds, thousands) of computing devices 104 and external servers 106 that are simultaneously connected to the network 108 at any given time.

Generally, the example computing system 100 includes a central server 102, a computing device 104, and an external server 106. Each of the central server 102, the computing device 104, and the external server 106 may communicate with the other devices (e.g., transmit data, instructions, etc.) across the network 108. As an example, the central server 102 and/or the external server 106 may belong to a healthcare provider or hospital and the computing device 104 may belong to a patient of the healthcare provider or hospital. In this example, the patient using the computing device 104 may transmit data (e.g., data including handwritten text data) to the central server 102, and the server 102 may perform data extraction (e.g., optical character recognition (OCR)) on the data and execute a certainty application 102d to generate data objects indicating certainty quotient(s) based on the extracted data. The central server 102 may additionally or alternatively make the data object accessible to the patient via the computing device 104, so the patient may review the data object to review the generated certainty quotient, portions of the extracted data, provide additional inputs concerning the certainty quotient or extracted data (e.g., confirming/denying the accuracy of extracted text data), and/or any other suitable actions or combinations thereof.

More specifically, the central server 102 may include one or more processors 102a, a memory 102b, and a networking interface 102c. The memory 102b may store executable instructions that are configured to, when executed by the one or more processors 102a, cause the one or more processors 102a to analyze data (e.g., data set 106d) received at the central server 102 and output various values (e.g., data objects indicating certainty quotients). The certainty application 102d, the machine-learned model 102e, the certainty models 102f, the confidence algorithm 102g, and/or the certainty data 102h may all include such executable instructions, as well as other data. The memory 102b may additionally or alternatively store additional data and/or databases. It should be appreciated that the central server 102 can include one or multiple computing devices that are co-located or distributed.

The central server 102 may receive data (e.g., data representative of a file) from the computing device 104 connected to the server 102 through a network 108 and process the data in accordance with one or more sets of instructions stored in a memory 102b to output any of the values described herein. The central server 102 may execute the certainty application 102d, which in turn, may access and apply the machine-learned model 102e, the certainty models 102f, the confidence algorithm 102g, and/or the certainty data 102h to the received data. The received data may generally include at least one file (e.g., a document including handwritten text) that may include text data to be extracted during a data extraction program (e.g., OCR). The text data may be distributed into one or more fields that may include one or more words. For example, a first file may be submitted by an individual as part of data transmitted from the computing device 104 and may include handwritten text data indicating the individual's name, address, and/or email address. In certain embodiments, the data transmitted to the central server 102 for analysis by the certainty application 102d may include voice data (e.g., from a phone call) and/or other data types that may be converted into text data, from which the application 102d may determine confidence scores, certainty quotients, and/or data objects based on such data.

The certainty application 102d may transmit and/or otherwise cause the data received at the central server 102 to be analyzed as part of a data extraction program/program, such as OCR. The certainty application 102d may communicate with the data extraction API, which may transmit extracted text data and metadata corresponding to the text data. For example, the metadata may include a position confidence score and/or a word confidence score associated with one or more fields and/or words included in the file analyzed by the data extraction program/program. In certain embodiments, the position confidence score may be included in the metadata corresponding to the text data and the content confidence score may be based on the metadata corresponding to the text data.

The certainty application 102d may execute the confidence algorithm 102g to generate a dictionary of words for up to each field in the file. The confidence algorithm 102g may cause the application 102d to generate the dictionary of words by including up to each word recognized by the data extraction program, along with its corresponding word-level confidence score and/or field level position confidence score. The word-level confidence score may generally indicate the data extraction model's confidence in the accuracy of an individual word identified and extracted from the file and is generally a numerical value typically ranging between 0 and 1 (e.g., scores closer to 1 indicate a higher confidence level in the correctness of the word's recognition). The field level position confidence score may generally indicate the data extraction model's confidence in the correct identification and positioning of a field within the file and is also generally a numerical value typically ranging between 0 to 1. The certainty application 102d may leverage this dictionary of words to accurately map words to their positions in the file fields.

The algorithm 102g may further cause the application 102d to associate up to each word in the dictionary of words with a span value and/or an offset value, which may collectively indicate the starting location of a word within the file. The span value may generally indicate the range within a field or file that a particular word occupies and may be represented as a combination of a starting point (e.g., offset) and a length value. The span value may thus generally outline the portion of the file where a particular word is found, making it possible for the application 102d to pinpoint the word's location within the file. The offset value may generally indicate the starting position of a word within a field and/or a file, such as a numerical value that represents the distance from the beginning of the file to the first character of the word. The confidence algorithm 102g may cause the application 102d to utilize the span value and the offset value within the dictionary of words as an index to map the character/word positions to the word that begins at that position. The application 102d may thereby utilize the dictionary of words to quickly identify a word within the file and its confidence score(s), e.g., based on the starting location of the word within the file.

For example, the confidence algorithm 102g may cause the application 102d to determine content confidence scores using the word confidence scores stored in the dictionary of words. The algorithm 102g may cause the application 102d to create a word confidence score array for the words present in the field based on the index mapping of the words in the dictionary of words (e.g., using the span values and offset values). The application 102d may populate the array with the word confidence scores associated with the words identified within the boundaries of the field. In certain embodiments, the algorithm 102g may cause the application 102d to determine the content confidence score for the field by determining the minimum word confidence score within the word confidence score array. In these embodiments, the content confidence score may represent the confidence level of the entire field's content, based on the assumption that the field's accuracy may be as reliable as its least confidently recognized word. In this manner, the algorithm 102g may ensure a conservative and realistic assessment of the field's content reliability to avoid missing identifying fields that may require additional review or verification due to the presence of words with low confidence scores. However, the confidence algorithm 102g may cause the application 102d to determine the content confidence scores in any suitable manner or combinations thereof.

As another example, the confidence algorithm 102g may cause the application 102d to determine the content confidence scores by assigning weights to up to each word confidence score for the words mapped in the dictionary of words to the field. The application 102d may assign up to each word confidence score a weight based on a predetermined and/or dynamic criterion. For example, the weights may be uniform, implying equal importance for all words, or the weights may vary based on factors such as the word's length, its position within the field, and/or its semantic importance to the field's content. The application 102d may calculate the weighted average of the word confidence scores by multiplying up to each word confidence score by its corresponding weight, summing these products, and then dividing the sum by the total of the weights to yield the content confidence score that represents the overall confidence in the field's content (e.g., taking into account the confidence scores of the words and their relative weights).

The confidence algorithm 102g may cause the certainty application 102d to determine the certainty score for a field based on the confidence scores. For example, the application 102d may utilize the content confidence score and the position confidence score (e.g., field level position confidence score) for a particular field, along with weights associated with the respective confidence scores to determine the certainty score. In certain embodiments, the weight associated with (e.g., applied to) the content confidence score may be greater than the weight associated with the position confidence score of the field.

By assigning a greater weight to the content confidence score than the positional confidence score, the algorithm 102g may place a greater emphasis on the accuracy of the content extracted from the file. This prioritization may indicate the relative importance of correctly identifying and understanding the text within a field, as accurate content influences the meaningful interpretation and subsequent use of the extracted data. In particular, the higher weight on the content confidence score may indicate that the correctness of the text itself may be more important to the overall certainty of the data than its precise location within the file. For example, the algorithm 102g may assign a weight ratio of 2:1 between the content confidence score and the positional confidence score to enable the algorithm 102g to balance precision in text recognition with the relevance of the text's position. Such a weighting strategy may ensure that the algorithm 102g does not overly penalize minor inaccuracies in field positioning as long as the content itself is accurately recognized.

The confidence algorithm 102g may cause the certainty application 102d to determine certainty scores for up to each field in a file, and the application 102d may utilize these certainty scores to determine the certainty quotient for the file. For example, the certainty application 102d may utilize the certainty scores for a particular file, along with weights associated with the respective certainty scores to determine the certainty quotient. The weights associated with respective certainty scores may generally correspond to the respective importance of the fields in the file, as not all fields in a file may carry the same level of importance with respect to the information they convey. Some fields may significantly contribute to the file's overall meaning, while others may be less significant. By assigning different weights to the certainty scores of various fields, the certainty quotient may accurately reflect the relative importance of up to each field, ensuring that more significant fields have a greater impact on the quotient.

In certain embodiments, the application 102d may determine the certainty quotient as a weighted average of the certainty scores associated with a file. The application 102d leveraging a weighted average may allow for a nuanced assessment of the overall accuracy of the extracted data because, instead of treating all fields equally, this approach may acknowledge the complexity of real-world files, where some inaccuracies may be more tolerable or less impactful than others. The resulting certainty quotient may thereby provide a more accurate and meaningful measure of the file's overall data extraction quality.

Further, the application 102d may adjust a corresponding certainty threshold for the certainty quotient based on any individual certainty quotient. The certainty threshold may generally indicate a minimum reliability value (e.g., 97%, 98% confidence extracted data is accurate) for data extracted from files of the file type associated with a particular file. Different applications or use cases may require focusing on different aspects of the extracted data, and such applications/use cases for particular file types may change over time. By adjusting the weights assigned to up to each field's certainty score, the application 102d may tailor the calculation of the certainty quotient to meet specific needs. This flexibility allows for the optimization of data extraction processes across a wide range of scenarios, enhancing the utility and relevance of the extracted data.

Moreover, in scenarios where the certainty quotient fails to meet or exceed the corresponding certainty threshold, the application 102d may analyze individual certainty scores to determine which fields of the file may have caused the certainty quotient to fail to satisfy the threshold. The application 102d may thereby enable targeted review and correction efforts, such as by the application 102d prioritizing fields that are more significant to the file's accuracy and overall utility.

The certainty application 102d may generate a data object indicating the certainty quotient and/or any additional data described herein. For example, the data object may indicate the certainty quotient and may provide a representation of a field that had a significantly low certainty score. In this example, the field indicating the individual's name (e.g., “John Doe”) may have a significantly low certainty score, and the data object output by the application 102d may indicate the certainty quotient (e.g., 95%) along with the extracted text corresponding to the field indicating the individual's name (e.g., incorrectly extracted as “Jane Doe”).

In certain embodiments, the certainty application 102d may use the content confidence score and the position confidence score to generate features corresponding to the scores and may input these features into the certainty models 102f to determine relationships between the confidence scores and extraction accuracy values. The extraction accuracy value generally indicates whether the set of confidence scores indicate accurate or inaccurate data extractions, and may thereby represent the number/rate of false positives and/or false negatives within the extracted data. The certainty models 102f may be models configured to determine these relationships, which may be best-fit boundaries that separate the features representing accurately extracted text from inaccurately extracted text. In certain embodiments, these certainty models 102f may include machine-learned models 102e, such as logistic regression models, random forest models, and/or other suitable models or combinations thereof.

To utilize the certainty models 102f, the certainty application 102d may transform the raw confidence scores into a format that can be more effectively utilized, e.g., by machine-learned models 102e. For example, the certainty application 102d may transform the raw confidence scores into features by squaring the confidence scores. The application 102d may thereby create new features that represent the interaction between the original content confidence score and the position confidence score, e.g., by helping to capture higher-order relationships between the scores, which may be significant when accurately modeling complex patterns in the data.

The application 102d may normalize these features (e.g., squared confidence scores) into a normalized value range (e.g., 0 to 1). Normalization may help ensure that no single feature dominates the certainty model 102f analysis due to scale differences by making the features more comparable. Thus, the application 102d may normalize the features to improve the certainty model's 120f generalization capabilities by ensuring that all features contribute relatively equally to the prediction process.

The application 102d may then utilize the certainty model(s) 102f to determine a relationship between the normalized features (e.g., normalized, squared confidence scores) and an extraction accuracy value. In certain embodiments, the certainty model(s) 102f may leverage examples where the true accuracy of data extractions is known, thereby establishing a relationship (e.g., a mathematical relationship) that may predict the likelihood of accuracy based on the input features.

The certainty application 102d may adjust any coefficients included as part of the certainty model's 102f relationship until the extraction accuracy value meets or exceeds an accuracy threshold. For example, where the relationship is a weighted polynomial, the application 102d may iteratively adjust the weights associated with the individual certainty scores until the certainty scores reliably indicate whether a particular field includes accurately extracted data. In certain embodiments, this adjustment process may include the application 102d iteratively refining the certainty model's 102f parameters, such as weights assigned to different features, to optimize its performance when determining the relationship.

Based on the established relationship, the certainty application 102d may determine the certainty score for up to each field in the document. As mentioned, the certainty score may generally indicate the likelihood that the data extracted from a particular field is accurate. More specifically, the certainty score may be a direct outcome of the certainty model's 102f learned relationship between confidence scores and extraction accuracy values, thereby enabling the application 102d to quantify the reliability of the extracted data.

More generally, the computing device 104 may be or include any one or more devices that is associated with (e.g., owned and/or operated by) one or more entities that may provide data (e.g., data) that is transmitted to and/or is otherwise accessible by the central server 102 and/or the external server 106 through the network 108. In certain embodiments, the user data transmitted to and/or otherwise accessible by the central server 102 and/or the external server 106 may be or include a set of text data, voice data, and/or other suitable data to be evaluated by the central server 102 and/or the external server 106. In some embodiments, the computing device 104 is a server or collection of servers hosting the data or a portion thereof, e.g., since the data may comprise data of multiple users received from different computing devices. However, in certain embodiments, the computing device 104 is a personal computing device of that entity/user, such as a smartphone, a tablet, smart glasses, or any other suitable device or combination of devices (e.g., a smart watch plus a smartphone) with wireless communication capability. In the embodiment of FIG. 1, the computing device 104 includes a processor 104a, a memory 104b, a networking interface 104c, and a display 104d.

The computing device 104 may be communicatively coupled to the central server 102 and/or the external server 106. For example, the computing device 104, the central server 102, and/or the external server 106 may communicate via USB, Bluetooth, Wi-Fi Direct, Near Field Communication (NFC), a private or public network (e.g., via an Internet protocol, such as IPv4, via a virtual private network (VPN)), etc. For example, the central server 102 may transmit a data object indicating a certainty quotient, an potion of the extracted text data, and/or any other values, responses, or combinations thereof to the computing device 104 via the networking interface 102c, which the computing device 104 may receive via the networking interface 104c.

The external server 106 may be or include computing servers and/or combinations of multiple servers storing data that may be accessed/retrieved by the central server 102 and/or the computing device 104. In certain embodiments, the external server 106 receives data from the central server 102 and/or the computing device 104 and retrieves/accesses information stored in memory 106b for transmission back to the central server 102 and/or the computing device 104. The external server 106 may include a processor 106a, a memory 106b, and a networking interface 106c. It should be appreciated that the external server 106 can include one or multiple computing devices that are co-located or distributed.

Further, in certain embodiments, the external server 106 includes a data set 106d including data from one or both of the computing device 104 and/or the central server 102. In one such example, the external server 106 is a server located in and/or otherwise associated with a hospital or other healthcare provider, and the data set 106d includes electronic health records, handwritten medical records from various physicians, and/or the like in memory 106b that may be used by the central server 102 (e.g., the certainty application 102d) to train certainty models 102f. As another example, the external server 106 serves as a database for some/all of the certainty data 102h. In some embodiments, the example computing system 100 does not include the external server 106.

Each of the processors 102a, 104a, 106a may include any suitable number of processors and/or processor types. For example, the processors 102a, 104a, 106a may each include one or more CPUs and one or more graphics processing units (GPUs). Generally, each of the processors 102a, 104a, 106a may be configured to execute software instructions stored in each of the corresponding memories 102b, 104b, 106b. The memories 102b, 104b, 106b may each include one or more persistent memories (e.g., a hard drive and/or solid-state memory) and may store one or more applications, modules, and/or models, such as the certainty application 102d.

The networking interface 102c may enable the central server 102 to communicate with the computing device 104, the external server 106, and/or any other suitable devices or combinations thereof. More specifically, the networking interface 102c may enable the central server 102 to communicate with each component of the example computing system 100 across the network 108 through their respective networking interfaces 104c, 106c. The networking interfaces 102c, 104c, 106c may support one or more of the communication/network protocols implemented by the network 108. The networking interface 102c may enable the central server 102 to communicate with the various components of the example computing system 100 via a wireless communication network such as a fifth-, fourth-, or third-generation cellular network (5G, 4G, or 3G, respectively), a Wi-Fi network (802.11 standards), a WiMAX network, or any other suitable wide area network (WAN), local area network (LAN), or personal area network (PAN), etc.

Moreover, the network 108 may be a single communication network, or may include multiple communication networks of one or more types (e.g., one or more wired and/or PANs or LANs, and/or one or more WANs such as the Internet). In some embodiments, the network 108 includes multiple, entirely distinct networks (e.g., one or more networks for communications between central server 102 and computing device 104, and a separate, Bluetooth or wireless LAN (WLAN) network for communications between central server 102 and computing device 104, and so on).

It will be understood that the above disclosure is one example and does not necessarily describe every possible embodiment. As such, it will be further understood that alternate embodiments may include fewer, alternate, and/or additional steps or elements.

### Example Computer-Implemented Processes

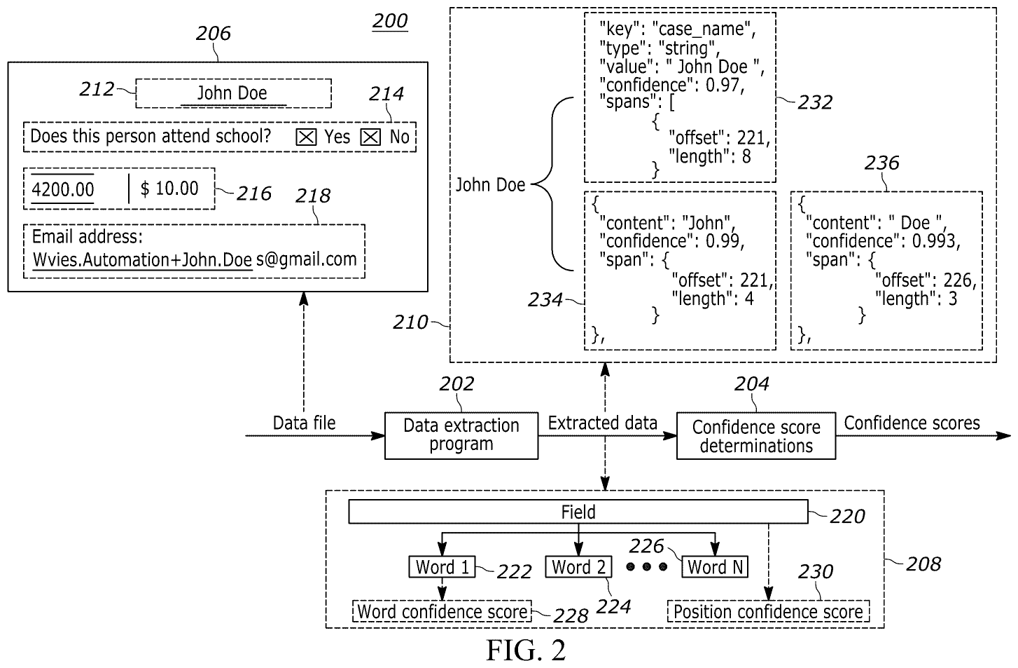

FIG. 2 depicts an example computer-implemented confidence score determination process 200, in accordance with various embodiments described herein. The example computer-implemented confidence score determination process 200 broadly illustrates the computer-implemented process 200 as a sequence of actions, although the computer-implemented process 200 may be executed in series, in parallel, or in any other order, and may be performed by central server 102 (e.g., processor 102a and/or other components of central server 102) of FIG. 1, for example, to receive data (e.g., a data file, extracted text data) as input and output confidence scores. The example computer-implemented confidence score determination process 200 illustrated in FIG. 2 is for the purposes of discussion only, and additional/alternative confidence score determination sequences may additionally or alternatively be utilized.

The computer-implemented confidence score determination process 200 may include receiving a data file and extracting data (e.g., text data) from the data file (block 202). As an example, the data file 206 may include multiple data fields 212, 214, 216, and 218, that may correspond to different sets of content within the data file 206. The first data field 212 may correspond to an individual's name, the second data field 214 may correspond to an indication of whether the individual attends school, the third data field 216 may correspond to a payment value, and the fourth data field 218 may correspond to the individual's email address.

The computer-implemented confidence score determination process 200 may include utilizing a data extraction program (e.g., OCR) to extract this text data from the data file 206, and the extracted data output by block 202 may include word confidence scores and position confidence scores. The general relationship between the extracted text data (e.g., fields and words) and the confidence scores is illustrated in block 208. Namely, a representative field 220 from the extracted data may include multiple words 222, 224, and 226, from a first word 222 to an Nth word 226, where N may be any integer. Up to each word 222-226 may include a corresponding word confidence score 228, from which the components described herein (e.g., certainty application 102d) may determine a content confidence score. The representative field 220 may also have a corresponding position confidence score 230.

The word confidence scores and the position confidence scores (e.g., 230) may be included as part of the metadata output as a result of the data extraction program 202, and may include values similar to those illustrated in the example confidence scores 210. For example, the example confidence scores 210 may include a set of confidence scores and other related data associated with the extracted text for the individual's name (e.g., John Doe). The first set of data 232 may include a position confidence score (e.g., 0.97) associated with the extraction program's confidence in the position of the field including the individual's name. The second set of data 234 may include a word confidence score (e.g., 0.99) associated with the individual's first name (e.g., “John”) and the third set of data 236 may include a word confidence score (e.g., 0.993) associated with the individual's last name (e.g., “Doe”). As depicted in the first, second, and third sets of data 232-236, the field associated with the individual's name the individual's first and last names may have distinct span values comprising distinct offset values and/or length values. For example, the first set of data 232 representing the field indicating the individual's name may have a span value comprising an offset value of two-hundred and twenty-one and a length value of eight. The second set of data 234 representing the text indicating the individual's first name may have a span value comprising an offset value of two-hundred and twenty-one and a length value of four, and the third set of data 236 representing the text indicating the individual's last name may have a span value comprising an offset value of two-hundred and twenty-six and a length value of three.

The computer-implemented confidence score determination process 200 may include using these confidence scores and/or other data (e.g., span values, offset values) to generate confidence scores (e.g., content confidence scores) that may be utilized to determine certainty scores, as described herein. For example, block 204 may include creating a dictionary of words that are extracted from a file (e.g., data file 206) by, in part, mapping these words to their positions within respective fields, creating a word confidence score array based on the word confidence scores of words included in a respective field of the file, and determining the content confidence score based on the word confidence scores included in the word confidence score array.

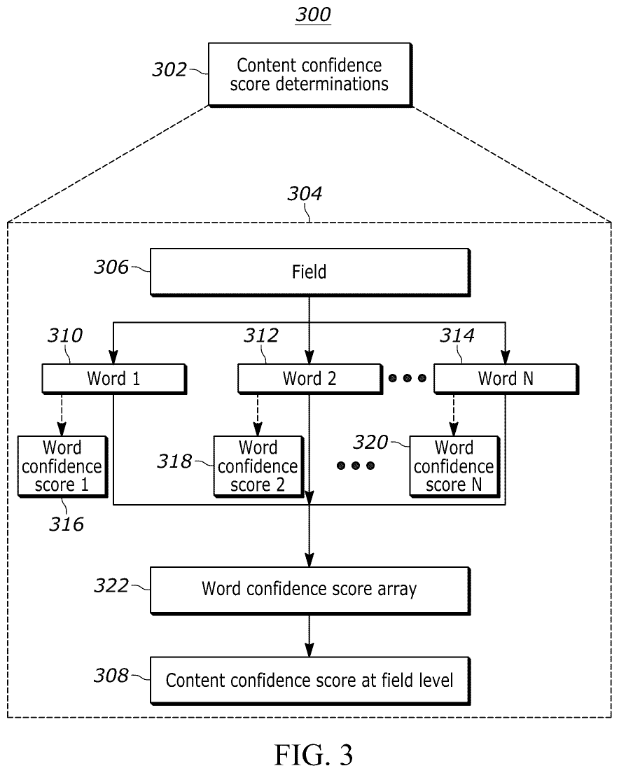

More specifically, FIG. 3 depicts an example computer-implemented content confidence score determination process 300, in accordance with various embodiments described herein. The example computer-implemented content confidence score determination process 300 broadly illustrates the computer-implemented process 300 as a sequence of actions, although the computer-implemented process 300 may be executed in series, in parallel, or in any other order, and may be performed by central server 102 (e.g., processor 102a and/or other components of central server 102) of FIG. 1, for example, to receive data (e.g., word confidence scores) as input and output content confidence scores. The example computer-implemented content confidence score determination process 300 illustrated in FIG. 3 is for the purposes of discussion only, and additional/alternative content confidence score determination sequences may additionally or alternatively be utilized.

The example computer-implemented content confidence score determination process 300 may include determining content confidence scores (block 302) based on the word confidence scores and/or the position confidence scores received, e.g., from a data extraction program. The content confidence score determination process may be generally represented by block 304, where the algorithms/applications described herein (e.g., certainty application 102d, confidence algorithm 102g) may receive extracted field/word data and word confidence scores and may output content confidence scores at a field level (e.g., content confidence score 308). In other words, the content confidence scores 308 output as a result of the actions illustrated in block 304 may generally represent the confidence that the content associated with the field 306 is accurate.

Block 304 may include the field 306, a first word 310, a second word 312, and an Nth word 314, where N is any integer. The applications/algorithms described herein may utilize the word confidence scores 316, 318, and 320 scores for up to each of the words 310-314, to create a word confidence score array 322, which includes up to each word confidence score 316-320 corresponding to a word 310-314 included as part of the field 306. In certain embodiments, block 304 may include determining the content confidence score 308 based on the word confidence score array 322 by determining a minimum word confidence score included in the word confidence score array 322.

For example, the word confidence score array 322 may include a set of word confidence scores comprising 0.99, 0.98, 0.97, and 0.95. The example computer-implemented content confidence score determination process 300 may include determining the content confidence score 308 by determining the minimum word confidence score included as part of the word confidence score array 322, such that the output of block 302 may comprise a content confidence score 308 of 0.95. This content confidence score 308 may represent the confidence level of the entire field's 306 content, based on the assumption that the field's 306 accuracy may be as reliable as its least confidently recognized word (e.g., word confidence score of 0.95). In this manner, the operations performed by block 302 may ensure a conservative and realistic assessment of the field's 306 content reliability.

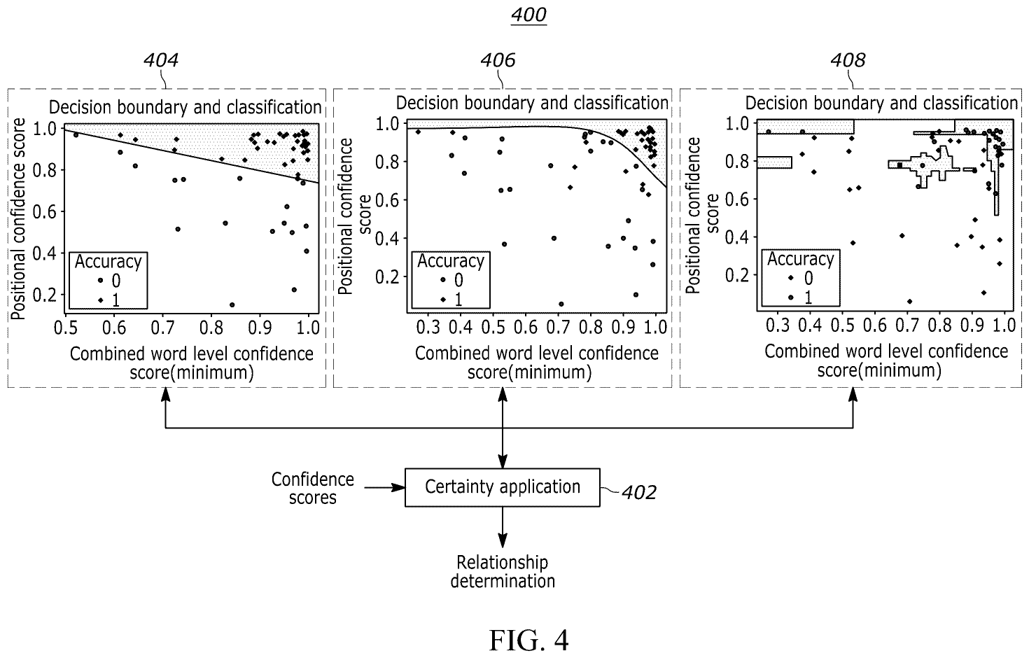

FIG. 4 depicts an example computer-implemented relationship determination process 400, in accordance with various embodiments described herein. The example computer-implemented relationship determination process 400 broadly illustrates the computer-implemented process 400 as a sequence of actions, although the computer-implemented process 400 may be executed in series, in parallel, or in any other order, and may be performed by central server 102 (e.g., processor 102a and/or other components of central server 102) of FIG. 1, for example, to receive confidence scores as input and output a certainty model determination. The example computer-implemented relationship determination process 400 illustrated in FIG. 4 is for the purposes of discussion only, and additional/alternative relationship determination sequences may additionally or alternatively be utilized.

The example computer-implemented relationship determination process 400 may generally illustrate a certainty application 402 (e.g., certainty application 102d) receiving confidence scores (e.g., content confidence scores, position confidence scores) of extracted data and determining a certainty model that best-fits features associated with the confidence scores. In some instances, the certainty application 402 may perform any subset of the actions described in reference to the example computer-implemented relationship determination process 400 as part of a training process with annotated/training data, such that the accuracy of the extracted data associated with the confidence scores, and by extension, the features described herein may be known. In these instances, the certainty application 402 may leverage multiple, different certainty models to model the relationship between the features and the accuracy of such features, and thereby determine which certainty model generates a best-fit of the data based on the known accuracy of the extracted data (e.g., 1 indicating accurately extracted data and 0 indicating inaccurately extracted data). The certainty application 402 may analyze the best-fit output by this model to determine and fine-tune a relationship between the confidence scores (e.g., features derived from the confidence scores) and an extraction accuracy value. As mentioned, the extraction accuracy values may generally indicate whether the set of confidence scores indicate accurate or inaccurate data extractions and may thereby represent the number/rate of false positives and/or false negatives within the extracted data.

The example computer-implemented relationship determination process 400 may include the certainty application 402 transforming the content confidence scores and position confidence scores through feature engineering, such as by squaring the confidence scores and normalizing them to a normalized value range of 0 to 1. The feature engineering performed by the application 402 may include creating new features and/or modifying existing features of the confidence scores and/or corresponding extracted data to better capture the nuances of the data. Accordingly, the application 402 may create new features that may capture interactions (e.g., non-linear relationships) between the original confidence scores, and may generally prepare the confidence scores for input into the certainty models.

The example computer-implemented relationship determination process 400 may include the application 402 plotting the features and utilizing one or more certainty models to determine a fit of the data that accurately delineates between accurately/inaccurately extracted data. More specifically, the application 402 may evaluate different models by plotting the transformed confidence scores (e.g., normalized features) on a scatter plot (e.g., scatter plots 404, 406, and 408) and attempting to find the best-fit curve that segregates accurate from inaccurate extractions using distinct certainty models. For example, the first scatter plot 404 may represent the fit achieved by the application 402 applying a linear regression certainty model to the normalized features, the second scatter plot 406 may represent the fit achieved by the application 402 applying a logistic regression certainty model to the normalized features, and the third scatter plot 408 may represent the fit achieved by the application 402 applying a random forest certainty model to the normalized features. The application 402 may determine that the logistic regression certainty model yields the best-fit boundary, which the application 402 may determine indicates that a polynomial curve may effectively segregate correctly and incorrectly recognized features. Accordingly, the application 402 may determine a polynomial expression to combine the features and determine the certainty score.

More generally, the best-fit boundary achieved by the certainty model applied by the certainty application 402 may not necessarily directly reflect the relationship the application 402 may use for determining certainty scores. The best-fit from the certainty model(s) may provide insights into the type of relationship (e.g., linear, polynomial, sigmoid, piecewise) that may best capture the association of the confidence scores and the extraction accuracy value. The example computer-implemented relationship determination process 400 may include the certainty application 402 determining a relationship (e.g., a polynomial expression) for determining the certainty score.

In certain embodiments, the application 402 may store the determined certainty score for use in determining the certainty score for file types corresponding to the file(s) from which the application 402 received/determined the confidence scores and normalized features used as inputs into the certainty model(s). Further, the application 402 may iteratively perform the certainty modeling described above to achieve the best-fit, such as by adjusting one or more parameters/weights of the underlying certainty models between subsequent iterations to achieve better fits to the normalized features. In particular, the application 402 may iteratively perform such modeling and adjustments to the models and determine an extraction accuracy value at up to each iteration until the application 402 determines that the extraction accuracy value meets or exceeds the accuracy threshold (e.g., no false positives).

Additionally, or alternatively, the certainty application 402 may determine different relationships for different file types (e.g., an invoice, a claims form, a patient intake form, etc.) that may have different sets of confidence scores that indicate accurate/inaccurate extracted text data. For example, a first file type (e.g., a patient intake form) may generally include lower confidence scores (e.g., 0.8 or higher) that indicate accurately extracted text data because individuals writing their responses into the respective fields of the form may do so quickly, which may lead to less legible/interpretable text. As another example, a second file type (e.g., a check) may generally include higher confidence scores (e.g., 0.95 or lower) that indicate inaccurately extracted text data because individuals writing a check may generally take time to ensure that the handwritten information (e.g., payment amount) is clearly legible to reduce instances of fraud, thereby creating more reliable extractions for this second file type than the first file type. In these instances, the certainty application 402 may utilize the certainty models to determine the best-fit relationships for the features of both file types and may determine different relationships that indicate the certainty scores for the different file types. For example, the first file type may have a quadratic polynomial curve relationship that represents the certainty score for that first file type, and the application 402 may determine that the second file type has a linear relationship that represents the certainty score for that second file type.

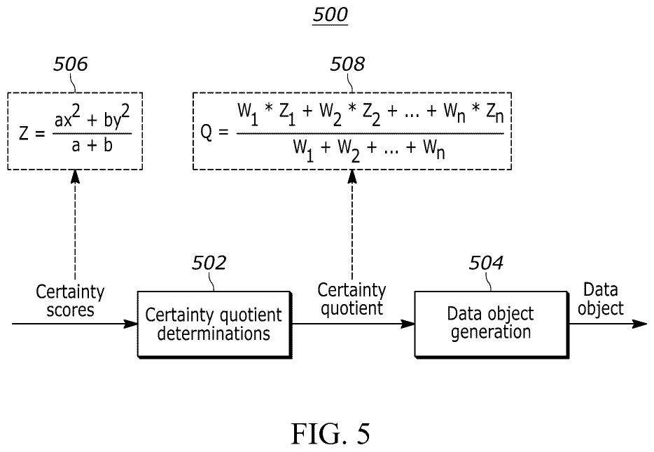

FIG. 5 depicts an example computer-implemented certainty quotient and data object determination process 500, in accordance with various embodiments described herein. The example computer-implemented certainty quotient and data object determination process 500 broadly illustrates the computer-implemented process 500 as a sequence of actions, although the computer-implemented process 500 may be executed in series, in parallel, or in any other order, and may be performed by central server 102 (e.g., processor 102a and/or other components of central server 102) of FIG. 1, for example, to receive certainty scores as input and output certainty quotients for inclusion/indication in a data object. The example computer-implemented certainty quotient and data object determination process 500 illustrated in FIG. 5 is for the purposes of discussion only, and additional/alternative certainty quotient and data object determination sequences may additionally or alternatively be utilized.

The example computer-implemented certainty quotient and data object determination process 500 generally includes the determining certainty quotients based on certainty scores (block 502) and determining data objects that may indicate the certainty quotient and/or other data (block 504). For example, the certainty quotient determinations 502 may include utilize certainty scores that are based on the following equation:

$$z = \frac{{ax}^{2} + {by}^{2}}{a + b} , \qquad ( 1 )$$

where z may be the certainty score for a particular field, x may be the content confidence score for the particular field, y may be the positional confidence score for the particular field, a may be the coefficient (e.g., weight) associated with content confidence score, and b may be the coefficient associated with position confidence score. The relationship represented by equation (1) is illustrated in FIG. 5 as an example relationship used to determine the received certainty scores. In certain embodiments, the coefficient associated with the content confidence score (a) may be two, and the coefficient associated with the position confidence score (b) may be one. Additionally, or alternatively, the components described herein (e.g., certainty application 402) may iteratively adjust these coefficients until the extraction accuracy value meets or exceeds an accuracy threshold (e.g., no false positives).

The example computer-implemented certainty quotient and data object determination process 500 may include determining the certainty quotient based on these certainty scores, and an example equation 508 representing a certainty quotient is illustrated in FIG. 5. The example equation 508 may be:

$$Q = \frac{{w}_{1} * {z}_{1} + {w}_{2} * {z}_{2} + … + {w}_{n} * {z}_{n}}{{w}_{1} + {w}_{2} + … + {w}_{n}} , \qquad ( 2 )$$

where Q may be the certainty quotient, z₁ may be the certainty score for a first field, z₂ may be the certainty score for a second field, zₙ may be the certainty score for an nth field (where n is any integer), w₁ may be a coefficient (e.g., weight) associated with the first field, w₂ may be a coefficient associated with the second field, and wₙ may be a coefficient associated with the nth field.

The example computer-implemented certainty quotient and data object determination process 500 may include determining the certainty quotient based on, for example, equation (2), and may include generating data objects that may indicate these certainty quotients (block 504). For example, a data object may indicate to a user that the certainty quotient for their input data is approximately 99%, such that the text data extracted by the data extraction program is very likely to be reliable/accurate. Of course, block 504 may include additional data in the data objects when generating such data objects. In certain embodiments, block 504 may include determining that at least one certainty score causes the certainty quotient to fail to meet or exceed a certainty threshold, and may include the certainty score, a representation of the field associated with the certainty score, and/or other suitable data. The certainty threshold may generally represent a minimum reliability value (e.g., 97% reliability confidence, 98%) for data extracted from the file. For example, block 504 may determine that a first certainty score associated with a field indicating an individual's name may cause the certainty quotient to fail to meet or exceed the certainty threshold (e.g., by failing to meet/exceed a certainty score threshold). Block 504 may generate a data object that indicates the certainty quotient and a graphical representation of the extracted text (e.g., “John Doe”) for viewing by the individual.

In certain embodiments, the example computer-implemented certainty quotient and data object determination process 500 may include determining/adjusting weights of the certainty quotient equation to achieve a more accurate certainty quotient. The blocks 502 and/or 504 may include utilizing statistical or machine learning methods to determine these weights. For example, the example computer-implemented certainty quotient and data object determination process 500 may include performing a statistical analysis to evaluate the impact of up to each field's reliability/accuracy on the overall reliability/accuracy of the data extracted from the file. Fields that consistently correlate with higher file accuracy when they are correctly extracted may be assigned higher weights in the certainty quotient equation (e.g., equation (2)). This statistical analysis may utilize historical file type data to identify patterns and/or correlations between the accuracy of specific fields of such file types and the overall document accuracy.

As another example, the example computer-implemented certainty quotient and data object determination process 500 may include utilizing machine learning models, such as decision trees or ensemble methods like random forests, to assess the importance of up to each field in predicting the overall reliability/accuracy of the data extracted from a file. These models may provide feature importance scores, which may be directly used as weights in the certainty quotient equation (e.g., equation (2)). The importance scores may indicate a relative significance for up to each field as part of the model's decision-making process, thereby providing an objective basis for weighting the fields in the certainty quotient equation.

As yet another example, the example computer-implemented certainty quotient and data object determination process 500 may include utilizing clustering analysis to group fields based on similarities in their confidence scores and their impact on the reliability/accuracy of the data extracted from a file. Fields within clusters that have a higher impact on accuracy may be assigned higher weights in the certainty quotient equation (e.g., equation (2)). In this manner, the example computer-implemented certainty quotient and data object determination process 500 may identify natural groupings of fields that behave similarly in terms of their contribution to accuracy and may facilitate a nuanced weighting scheme.

As one example, the example computer-implemented certainty quotient and data object determination process 500 may include conducting an error sensitivity analysis to determine how errors in specific fields may affect the overall reliability/accuracy of data extracted from a file. Fields that, when inaccurately extracted, lead to significant decreases in document reliability/accuracy may be assigned higher weights. Such an approach may focus on the negative impact of inaccuracies, ensuring that fields relevant to maintaining high overall reliability/accuracy are prioritized in the certainty quotient equation (e.g., equation (2)).

As another example, the example computer-implemented certainty quotient and data object determination process 500 may include using cross-validation techniques to experiment with different weighting schemes across a subset of data, optimizing for the highest overall reliability/accuracy of the extracted data from a file. The weights that result in the highest reliability/accuracy during cross-validation may then be applied to the certainty quotient equation (e.g., equation (2)).

As still another example, the example computer-implemented certainty quotient and data object determination process 500 may include building and/or otherwise utilizing a regression model with the overall reliability/accuracy of the extracted data from a file as the dependent variable and the certainty scores of individual fields as independent variables. The coefficients obtained from the regression model may serve as weights, indicating the relative contribution of up to each field's certainty score to the overall reliability/accuracy of the extracted data from the file.

In certain embodiments, the example computer-implemented certainty quotient and data object determination process 500 may include determining, based on the certainty quotient, a file certainty threshold for one or more file types. The file certainty threshold may generally indicate a minimum reliability value for data extracted from files of the file type. For example, the computer-implemented process 500 may include determining that a file is of a particular file type (e.g., a check, a patient intake form, an invoice), and thereafter determining certainty scores and a certainty quotient for the file based on the respective certainty score/quotient corresponding to the particular file type. Moreover, the example computer-implemented certainty quotient and data object determination process 500 may iteratively update/adjust the certainty quotient equation (e.g., equation (2)), the certainty score equations (e.g., equation (1)), such as weights or overall mathematical structure, and/or thresholds associated therewith based on updated file data.

For example, the components described herein may receive extracted data from a first file having a first file type, and the first file may include text extracted from a new field that has not included text in any file of the first file type prior to the first file. The components described herein may analyze the fields and words of the first file to determine confidence scores (e.g., content confidence scores, position confidence scores), generate certainty scores for the fields (including the new field), and determine a certainty quotient for the first file. If the certainty quotient for the first file does not satisfy the certainty threshold, the example computer-implemented certainty quotient and data object determination process 500 may include determining whether any of the other fields (e.g., other than the new field) failed to satisfy any individual certainty score thresholds. If not, and the components described herein determine that the certainty quotient failed to meet or exceed the certainty threshold because the certainty score for the new field was particularly low, the example computer-implemented certainty quotient and data object determination process 500 may include adjusting the certainty quotient equation (e.g., equation (2)) and/or the certainty score equation (e.g., equation (1)) for the file to account for the new field, as described herein.

### Example Computer-Implemented Methods

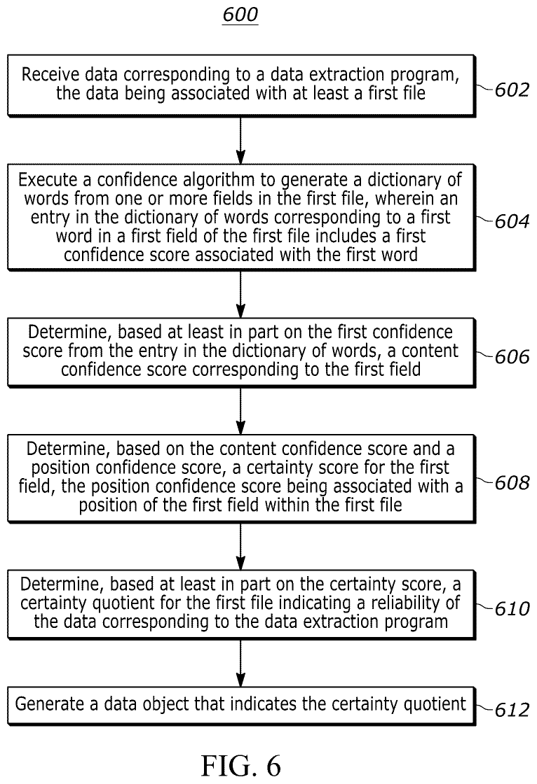

FIG. 6 depicts a flow diagram representing an example computer-implemented method 600, in accordance with various embodiments described herein. The method 600 may be implemented by one or more processors of the example computing system 100, such as the processor 102a of central server 102 (e.g., by certainty application 102d), for example.

The computer-implemented method 600 may include receiving data corresponding to a data extraction program (block 602). The data may be associated with at least a first file. The computer-implemented method 600 may further include executing a confidence algorithm to generate a dictionary of words from one or more fields in the first file (block 604). An entry in the dictionary of words corresponding to a first word in a first field of the first file may include a first confidence score associated with the first word. The computer-implemented method 600 may further include determining, based at least in part on the first confidence score from the entry in the dictionary of words, a content confidence score corresponding to the first field (block 606).

The computer-implemented method 600 may further include determining, based on the content confidence score and a position confidence score, a certainty score for the first field (block 608). The position confidence score may be associated with a position of the first field within the first file. The computer-implemented method 600 may further include determining, based at least in part on the certainty score, a certainty quotient for the first file indicating a reliability of the data corresponding to the data extraction program (block 610). The computer-implemented method 600 may further include generating a data object that indicates the certainty quotient.

In certain embodiments, generating the dictionary of words may include determining, by the one or more processors, a span value and an offset value of the first word, wherein the entry in the dictionary of words includes (i) the span value, (ii) the offset value, and (iii) the first confidence score. In these embodiments, the computer-implemented method 600 may include generating, by the one or more processors based on span values and offset values indicated in the dictionary of words, a word confidence score array indicating respective word confidence scores for words present in the first field, and determining, by the one or more processors based on the word confidence score array, the content confidence score.

In certain embodiments, wherein the content confidence score and the position confidence score are part of a set of confidence scores associated with the first file, and the computer-implemented method 600 may include determining, by a certainty model, a relationship between the set of confidence scores and an extraction accuracy value indicating whether the set of confidence scores indicate accurate or inaccurate data extractions; adjusting, by the one or more processors, coefficients included as part of the relationship until the extraction accuracy value meets or exceeds an accuracy threshold; and determining, by the one or more processors based on the relationship, the certainty score for the first field.

In certain embodiments, the certainty model is a first certainty model, and the computer-implemented method 600 may include receiving, by one or more processors, data associated with a second file that is different from the first file; determining, based on a second certainty model, a second relationship between confidence scores of the second file and a second extraction accuracy value, wherein the second certainty model is different from the first certainty model; adjusting, by the one or more processors, coefficients included as part of the second relationship until the second extraction accuracy value meets or exceeds a second accuracy threshold; and determining, based on the second relationship, a second certainty score for a field of the second file.

In certain embodiments, the certainty model is a machine-learned model, the relationship corresponds to a best-fit boundary determined by the machine-learned model, and the best-fit boundary separates a portion of the set of confidence scores that indicate accurate data extractions from another portion of the set of confidence scores that indicate inaccurate data extractions.

In certain embodiments, the computer-implemented method 600 may include generating, by the one or more processors based on the content confidence score and the position confidence score, an adjusted feature that represents interactions between the content confidence score and the position confidence score; determining, by the one or more processors based on the adjusted feature, a normalized feature by adjusting a value of the adjusted feature to be within a normalized value range; and determining, by the certainty model based at least in part on the normalized feature, the relationship between the set of confidence scores and the extraction accuracy value.

In certain embodiments, the computer-implemented method 600 may include determining, by the one or more processors, that at least the certainty score causes the certainty quotient to fail to meet or exceed a certainty threshold; and generating, by the one or more processors, the data object to indicate (i) the certainty quotient and (ii) a representation of the first field of the first file.

In certain embodiments, the computer-implemented method 600 may include determining, by the one or more processors, the content confidence score and the position confidence score based on metadata included as part of the data corresponding to the data extraction program.

In certain embodiments, the computer-implemented method 600 may include determining, based on the certainty quotient, a file certainty threshold for a file type associated with the first file, the file certainty threshold indicating a minimum reliability value for data extracted from files of the file type; receiving, by the one or more processors, data associated with a second file of the file type; determining, by the one or more processors, a second certainty quotient corresponding to the second file; determining, by the one or more processors, whether the second certainty quotient satisfies the file certainty threshold; and responsive to determining that the second certainty quotient fails to meet or exceed the file certainty threshold, adjusting, by the one or more processors based on the second certainty quotient, the file certainty threshold.

Of course, it is to be appreciated that the actions of the method 600 may be performed any suitable number of times, and that the actions described in reference to the method 600 may be performed in any suitable order.

### EXAMPLES

Example 1. A computer-implemented method comprising: receiving, by one or more processors, data corresponding to a data extraction program, the data being associated with at least a first file; executing, by the one or more processors, a confidence algorithm that causes the one or more processors to perform operations comprising: generating a dictionary of words from one or more fields in the first file, wherein an entry in the dictionary of words corresponding to a first word in a first field of the first file includes a first confidence score associated with the first word, determining, based at least in part on the first confidence score from the entry in the dictionary of words, a content confidence score corresponding to the first field, and determining, based on the content confidence score and a position confidence score, a certainty score for the first field, the position confidence score being associated with a position of the first field within the first file; determining, by the one or more processors based at least in part on the certainty score, a certainty quotient for the first file indicating a reliability of the data corresponding to the data extraction program; and generating, by the one or more processors, a data object that indicates the certainty quotient.

Example 2. The computer-implemented method of example 1, wherein: generating the dictionary of words further comprises: determining, by the one or more processors, a span value and an offset value of the first word, wherein the entry in the dictionary of words includes (i) the span value, (ii) the offset value, and (iii) the first confidence score; and the computer-implemented method further comprises: generating, by the one or more processors based on span values and offset values indicated in the dictionary of words, a word confidence score array indicating respective word confidence scores for words present in the first field, and determining, by the one or more processors based on the word confidence score array, the content confidence score.

Example 3. The computer-implemented method of example 1 or 2, wherein the content confidence score and the position confidence score are part of a set of confidence scores associated with the first file, and the computer-implemented method further comprises: determining, by a certainty model, a relationship between the set of confidence scores and an extraction accuracy value indicating whether the set of confidence scores indicate accurate or inaccurate data extractions; adjusting, by the one or more processors, coefficients included as part of the relationship until the extraction accuracy value meets or exceeds an accuracy threshold; and determining, by the one or more processors based on the relationship, the certainty score for the first field.

Example 4. The computer-implemented method of example 3, wherein the certainty model is a first certainty model, and the computer-implemented method further comprises: receiving, by one or more processors, data associated with a second file that is different from the first file; determining, based on a second certainty model, a second relationship between confidence scores of the second file and a second extraction accuracy value, wherein the second certainty model is different from the first certainty model; adjusting, by the one or more processors, coefficients included as part of the second relationship until the second extraction accuracy value meets or exceeds a second accuracy threshold; and determining, based on the second relationship, a second certainty score for a field of the second file.

Example 5. The computer-implemented method of example 3 or 4, wherein the certainty model is a machine-learned model, the relationship corresponds to a best-fit boundary determined by the machine-learned model, and the best-fit boundary separates a portion of the set of confidence scores that indicate accurate data extractions from another portion of the set of confidence scores that indicate inaccurate data extractions.

Example 6. The computer-implemented method of any of examples 3 through 5, further comprising: generating, by the one or more processors based on the content confidence score and the position confidence score, an adjusted feature that represents interactions between the content confidence score and the position confidence score; determining, by the one or more processors based on the adjusted feature, a normalized feature by adjusting a value of the adjusted feature to be within a normalized value range; and determining, by the certainty model based at least in part on the normalized feature, the relationship between the set of confidence scores and the extraction accuracy value.

Example 7. The computer-implemented method of any of examples 1 through 6, further comprising: determining, by the one or more processors, that at least the certainty score causes the certainty quotient to fail to meet or exceed a certainty threshold; and generating, by the one or more processors, the data object to indicate (i) the certainty quotient and (ii) a representation of the first field of the first file.

Example 8. The computer-implemented method of any of examples 1 through 7, further comprising: determining, by the one or more processors, the content confidence score and the position confidence score based on metadata included as part of the data corresponding to the data extraction program.

Example 9. The computer-implemented method of any of examples 1 through 8, further comprising: determining, based on the certainty quotient, a file certainty threshold for a file type associated with the first file, the file certainty threshold indicating a minimum reliability value for data extracted from files of the file type; receiving, by the one or more processors, data associated with a second file of the file type; determining, by the one or more processors, a second certainty quotient corresponding to the second file; determining, by the one or more processors, whether the second certainty quotient satisfies the file certainty threshold; and responsive to determining that the second certainty quotient fails to meet or exceed the file certainty threshold, adjusting, by the one or more processors based on the second certainty quotient, the file certainty threshold.

Example 10. A system comprising: one or more processors; and at least one memory storing processor-executable instructions that, when executed by the one or more processors, cause the one or more processors to perform operations comprising: receiving data corresponding to a data extraction program, the data being associated with at least a first file; executing a confidence algorithm that causes the one or more processors to perform operations comprising: generating a dictionary of words from one or more fields in the first file, wherein an entry in the dictionary of words corresponding to a first word in a first field of the first file includes a first confidence score associated with the first word, determining, based at least in part on the first confidence score from the entry in the dictionary of words, a content confidence score corresponding to the first field, and determining, based on the content confidence score and a position confidence score, a certainty score for the first field, the position confidence score being associated with a position of the first field within the first file; determining, based at least in part on the certainty score, a certainty quotient for the first file indicating a reliability of the data corresponding to the data extraction program; and generating a data object that indicates the certainty quotient.

Example 11. The system of example 10, wherein the processor-executable instructions, when executed by the one or more processors, further cause the one or more processors to perform operations comprising: determining a span value and an offset value of the first word, wherein the entry in the dictionary of words includes (i) the span value, (ii) the offset value, and (iii) the first confidence score; generating, based on span values and offset values indicated in the dictionary of words, a word confidence score array indicating respective word confidence scores for words present in the first field; and determining, based on the word confidence score array, the content confidence score.

Example 12. The system of example 10 or 11, wherein the content confidence score and the position confidence score are part of a set of confidence scores associated with the first file, and the processor-executable instructions, when executed by the one or more processors, further cause the one or more processors to perform operations comprising: determining, by a certainty model, a relationship between the set of confidence scores and an extraction accuracy value indicating whether the set of confidence scores indicate accurate or inaccurate data extractions; adjusting coefficients included as part of the relationship until the extraction accuracy value meets or exceeds an accuracy threshold; and determining, based on the relationship, the certainty score for the first field.

Example 13. The system of example 12, wherein the certainty model is a first certainty model, and the processor-executable instructions, when executed by the one or more processors, further cause the one or more processors to perform operations comprising: receiving data associated with a second file that is different from the first file; determining, based on a second certainty model, a second relationship between confidence scores of the second file and a second extraction accuracy value, wherein the second certainty model is different from the first certainty model; adjusting coefficients included as part of the second relationship until the second extraction accuracy value meets or exceeds a second accuracy threshold; and determining, based on the second relationship, a second certainty score for a field of the second file.

Example 14. The system of example 12 or 13, wherein the certainty model is a machine-learned model, the relationship corresponds to a best-fit boundary determined by the machine-learned model, and the best-fit boundary separates a portion of the set of confidence scores that indicate accurate data extractions from another portion of the set of confidence scores that indicate inaccurate data extractions.

Example 15. The system of any of examples 12 through 14, wherein the processor-executable instructions, when executed by the one or more processors, further cause the one or more processors to perform operations comprising: generating, based on the content confidence score and the position confidence score, an adjusted feature that represents interactions between the content confidence score and the position confidence score; determining, based on the adjusted feature, a normalized feature by adjusting a value of the adjusted feature to be within a normalized value range; and determining, based at least in part on the normalized feature, the relationship between the set of confidence scores and the extraction accuracy value.

Example 16. The system of any of examples 10 through 15, wherein the processor-executable instructions, when executed by the one or more processors, further cause the one or more processors to perform operations comprising: determining that at least the certainty score causes the certainty quotient to fail to meet or exceed a certainty threshold; and generating the data object to indicate (i) the certainty quotient and (ii) a representation of the first field of the first file.

Example 17. The system of any of examples 10 through 16, wherein the processor-executable instructions, when executed by the one or more processors, further cause the one or more processors to perform operations comprising: determining the content confidence score and the position confidence score based on metadata included as part of the data corresponding to the data extraction program.

Example 18. The system of any of examples 10 through 17, wherein the processor-executable instructions, when executed by the one or more processors, further cause the one or more processors to perform operations comprising: determining, based on the certainty quotient, a file certainty threshold for a file type associated with the first file, the file certainty threshold indicating a minimum reliability value for data extracted from files of the file type; receiving data associated with a second file of the file type; determining a second certainty quotient corresponding to the second file; determining whether the second certainty quotient satisfies the file certainty threshold; and responsive to determining that the second certainty quotient fails to meet or exceed the file certainty threshold, adjusting, based on the second certainty quotient, the file certainty threshold.

Example 19. One or more non-transitory computer-readable media storing processor-executable instructions that, when executed by one or more processors, cause the one or more processors to perform operations comprising: receiving data corresponding to a data extraction program, the data being associated with at least a first file; executing a confidence algorithm that comprises: generating a dictionary of words from one or more fields in the first file, wherein an entry in the dictionary of words corresponding to a first word in a first field of the first file includes a first confidence score associated with the first word, determining, based at least in part on the first confidence score from the entry in the dictionary of words, a content confidence score corresponding to the first field, and determining, based on the content confidence score and a position confidence score, a certainty score for the first field, the position confidence score being associated with a position of the first field within the first file; determining, based at least in part on the certainty score, a certainty quotient for the first file indicating a reliability of the data corresponding to the data extraction program; and generating a data object that indicates the certainty quotient.

Example 20. The one or more non-transitory computer-readable media of example 19, wherein the processor-executable instructions, when executed by the one or more processors, further cause the one or more processors to perform operations comprising: determining a span value and an offset value of the first word, wherein the entry in the dictionary of words includes (i) the span value, (ii) the offset value, and (iii) the first confidence score; generating, based on span values and offset values indicated in the dictionary of words, a word confidence score array indicating respective word confidence scores for words present in the first field; and determining, based on the word confidence score array, the content confidence score.

Example 21. The computer-implemented method of example 5, wherein the machine-learned model is fine-tuned by the one or more processors.

Example 22. The computer-implemented method of example 5, wherein: the one or more processors are included in a first computing entity; and the machine-learned model is fine-tuned by one or more processors included in a second computing entity.

### Additional Considerations

Throughout this specification, components, operations, or structures described as a single instance may be implemented as multiple instances. Although individual operations of one or more methods (or processes, techniques, routines, etc.) are illustrated and described as separate operations, two or more of the individual operations may be performed concurrently or otherwise in parallel, and nothing requires that the operations be performed in the order illustrated. Structures and functionality (e.g., operations, steps, blocks) presented as separate components in example configurations may be implemented as a combined structure, functionality, or component. Similarly, structures and functionality presented as a single component may be implemented as separate components. These and other variations, modifications, additions, and improvements fall within the scope of the subject matter herein.

Certain embodiments are described herein as including logic or a number of routines, subroutines, applications, operations, blocks, or instructions. These may constitute and/or be implemented by software (e.g., code embodied on a non-transitory, machine-readable medium), hardware, or a combination thereof. In hardware, the routines, etc., may represent tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware component that operates to perform certain operations as described herein.

In various embodiments, a hardware component may be implemented mechanically or electronically. For example, a hardware component may comprise dedicated circuitry or logic that is permanently configured (e.g., as a special-purpose processor, such as a field programmable gate array (FPGA) or an application-specific integrated circuit (ASIC)) to perform certain operations. A hardware component may also or instead comprise programmable logic or circuitry (e.g., as encompassed within one or more general-purpose processors and/or other programmable processor(s)) that is temporarily configured by software to perform certain operations.

Accordingly, the term “hardware component” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where the hardware components include a general-purpose processor configured using software, the general-purpose processor may be configured as respective different hardware components at different times. Software may accordingly configure a processor, for example, to constitute a particular hardware component at one instance of time and to constitute a different hardware component at a different instance of time.

Hardware components can provide information to, and receive information from, other hardware components. Accordingly, the described hardware components may be regarded as being communicatively coupled. Where multiple of such hardware components exist contemporaneously, communications may be achieved through signal transmission (e.g., over appropriate circuits and buses) that connect the hardware components. In embodiments in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information).

As noted above, the various operations of example methods (or processes, techniques, routines, etc.) described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Moreover, each operation of processes illustrated as logical flow graphs may represent a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular data types. The order in which the operations are described is not intended to be construed as a limitation, and any number of the described operations can be combined in any order and/or in parallel to implement the processes.

The terms “coupled” and “connected,” along with their derivatives, may be used. In particular embodiments, “connected” may be used to indicate that two or more elements are in direct physical or electrical contact with each other, although the context in the description may dictate otherwise when it is apparent that two or more elements are not in direct physical or electrical contact. “Coupled” may mean that two or more elements are in direct physical or electrical contact. However, “coupled” may also mean that two or more elements are not in direct contact with each other, yet still co-operate, transmit between, or interact with each other.

An algorithm may be considered to be a self-consistent sequence of acts or operations leading to a desired result. These include physical manipulations of physical quantities. Usually, though not necessarily, these quantities take the form of electrical, magnetic, or optical signals capable of being stored, transferred, combined, compared, and otherwise manipulated. These signals are commonly referred to as bits, values, elements, symbols, characters, terms, numbers, flags, or the like. It should be understood, however, that all of these and similar terms are to be associated with the appropriate physical quantities and are merely convenient labels applied to these quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments,” “one embodiment,” “an embodiment,” “in some examples,” or variations thereof means that a particular element, feature, structure, characteristic, operation, or the like described in connection with the embodiment is included in at least one embodiment, but not every embodiment necessarily includes the particular element, feature, structure, characteristic, operation, or the like. Different instances of such a reference in various places in the specification do not necessarily all refer to the same embodiment, although they may in some cases. Moreover, different instances of such a reference may describe elements, features, structures, characteristics, operations, or the like be combined in any manner as an embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless the context of use clearly indicates otherwise, “or” refers to an inclusive or and not to an exclusive or. For example, a condition A or B is satisfied by any one of the following: A is true (or present) and B is false (or not present), A is false (or not present) and B is true (or present), and both A and B are true (or present).

The term “set” is intended to mean a collection of elements and can be a null set (i.e., a set containing zero elements) or may comprise one, two, or more elements. A “subset” is intended to mean a collection of elements that are all elements of a set, but that does not include other elements of the set. A first subset of a set may comprise zero, one, or more elements that are also elements of a second subset of the set. The first subset may be said to be a subset of the second subset if all the elements of the first subset are elements of the second subset, while also being a subset of the set. However, if all the elements of the second subset are also elements of the first subset (in addition to all the elements of the first subset being elements of the second subset), the first subset and the second subset are a single subset/not distinct.

For the purposes of the present disclosure, the term “a” or “an” entity refers to one or more of that entity. As such, the terms “a” or “an”, “one or more”, and “at least one” can be used interchangeably herein unless explicitly contradicted by the specification using the word “only one” or similar. For example, “a first element” may functionally be interpreted as “a first one or more elements” or a “first at least one element.” Unless otherwise apparent from the context of use, reference in the present disclosure to a same set of “one or more processors” (or a same “plurality of processors,” etc.) performing multiple operations can encompass implementations in which performance of the operations is divided among the processor(s) in any suitable way. For example, “generating, by one or more processors, X; and generating, by the one or more processors, Y” can encompass: (1) implementations in which a first subset of the processors (e.g., in a first computing device) generates X and an entirely distinct, second subset of the processors (e.g., in a different, second computing device) independently generates Y; (2) implementations in which one or more or all of the processor(s) (e.g., one or multiple processors in the same device, or multiple processors distributed among multiple devices) contribute to the generation of X and/or Y; and (3) other variations. This may similarly be applied to any other component or feature similarly recited (e.g., as “a component”, “a feature”, “one or more components”, “one or more features”, “a plurality of components”, “a plurality of features”). Moreover, the performance of certain of the operations may be distributed among the one or more components, not only residing within a single machine, but deployed across a number of machines. The set of components may be located in a single geographic location (e.g., within a home environment, an office environment, a cloud environment). In other example embodiments, the set of components may be distributed across two or more geographic locations. Further, “a machine-learned model”, equivalent terms (e.g., “machine-learned model,” “machine-learning model,” “machine-learned component”, “artificial intelligence”, “artificial intelligence component”), or species thereof (e.g., “a large language model”, “a neural network”) may include a single machine-learned model or multiple machine-learned models, such as a pipeline comprising two or more machine-learned models arranged in series and/or parallel, an agentic framework of machine-learned models, or the like.

An “artificial intelligence” or “artificial intelligence component” may comprise a machine-learned model. A machine-learned model may comprise a hardware and/or software architecture having structural hyperparameters defining the model's architecture and/or one or more parameters (e.g., coefficient(s), weight(s), biase(s), activation function(s) and/or action function type(s) in examples where the activation function and/or function type is determined as part of training, clustering centroid(s)/medoid(s), partition(s), number of trees, tree depth, split parameters) determined as a result of training the machine-learned model based at least in part on training hyperparameters (e.g., for supervised, semi-supervised, and reinforcement learning models) and/or by iteratively operating the machine-learned model according to the training hyperparameters (e.g., for unsupervised machine-learned models).

In some examples, structural hyperparameter(s) may define component(s) of the model's architecture and/or their configuration/order, such as, for example, the configuration/order specifying which input(s) are provided to one component and which output(s) of that component are provided as input to other component(s) of the machine-learned model; a number, type, and/or configuration of component(s) per layer; a number of layers of the model; a number and/or type of input nodes in an input layer of the model; a number and/or type of nodes in a layer; a number and/or type of output nodes of an output layer of the model; component dimension (e.g., input size versus output size); a number of trees; a maximum tree depth; node split parameters; minimum number of samples in a leaf node of a tree; and/or the like. The component(s) of the model may comprise one or more activation functions and/or activation function type(s) (e.g., gated linear unit (GLU), such as a rectified linear unit (ReLU), leaky RELU, Gaussian error linear unit (GELU), Swish, hyperbolic tangent), one or more attention mechanism and/or attention mechanism types (e.g., self-attention, cross-attention), nodes and split indications and/or probabilities in a decision tree, and/or various other component(s) (e.g., adding and/or normalization layer, pooling layer, filter). Various combinations of any these components (as defined by the structural hyperparameter(s)) may result in different types of model architectures, such as a transformer-based machine-learned model (e.g., encoder-only model(s), encoder-decoder model(s), decoder-only models, generative pre-trained transformer(s) (GPT(s))), neural network(s), multi-layer perceptron(s), Kolmogorov-Arnold network(s), clustering algorithm(s), support vector machine(s), gradient boosting machine(s), and/or the like. The structural parameters and components a machine-learned model comprises may vary depending on the type of machine-learned model.

Training hyperparameter(s) may be used as part of training or otherwise determining the machine-learned model. In some examples, the training hyperparameter(s), in addition to the training data and/or input data, may affect determining the parameter(s) of the target machine-learned model. Using a different set of training hyperparameters to train two machine-learned models that have the same architecture (i.e., the same structural hyperparameters) and using the same training data may result in the parameters of the first machine-learned model differing from the parameters of the second machine-learned model. Despite having the same architecture and having been trained using the same training data, such machine-learned models may generate different outputs from each other, given the same input data. Accordingly, accuracy, precision, recall, and/or bias may vary between such machine-learned models.

In some examples, training hyperparameter(s) may include a train-test split ratio, activation function and/or activation function type (e.g., in examples like Kolmogorov-Arnold networks (KANs) where the activation function type is determined as part of training from an available set of activation functions and/or limits on the activation function parameters specified by the training hyperparameters), training stage(s) (e.g., using a first set of hyperparameters for a first epoch of training, a second set of hyperparameters for a second epoch of training), a batch size and/or number of batches of data in a training epoch, a number of epochs of training, the loss function used (e.g., L1, L2, Huber, Cauchy, cross entropy), the component(s) of the machine-learned model that are altered using the loss for a particular batch or during a particular epoch of training (e.g., some components may be “frozen,” meaning their parameters are not altered based on the loss), learning rate, learning rate optimization algorithm type (e.g., gradient descent, adaptive, stochastic) used to determine an alteration to one or more parameters of one or more components of the machine-learned model to reduce the loss determined by the loss function, learning rate scheduling, and/or the like.

In some examples, the structural hyperparameters and/or the training hyperparameters may be determined by a hyperparameter optimization algorithm or based on user input, such as a software component written by a user or generated by a machine-learned model. The machine-learned model may include any type of model configured, trained, and/or the like to generate a prediction output for a model input. In some examples, any of the logic, component(s), routines, and/or the like discussed herein may be implemented as a machine-learned model.

The machine-learned model may include one or more of any type of machine-learned model including one or more supervised, unsupervised, semi-supervised, and/or reinforcement learning models. Training a machine-learned model may comprise altering one or more parameters of the machine-learned model (e.g., using a loss optimization algorithm) to reduce a loss. Depending on whether the machine-learned model is supervised, semi-supervised, unsupervised, etc. this loss may be determined based at least in part on a difference between an output generated by the model and ground truth data (e.g., a label, an indication of an outcome that resulted from a system using the output), a cost function, a fit of the parameter(s) to a set of data, a fit of an output to a set of data, and/or the like. In some examples, determining an output by a machine-learned model may comprise executing a set of inference operations executed by the machine-learned model according to the target machine-learned model's parameter(s) and structural hyperparameter(s) and using/operating on a set of input data.

Moreover, any discussion of receiving data associated with an individual that may be protected, confidential, or otherwise sensitive information, is understood to have been preceded by transmitting a notice of use of the data to a computing device, account, or other identifier (collectively, “identifier”) associated with the individual, receiving an indication of authorization to use the data from the identifier, and/or providing a mechanism by which a user may cause use of the data to cease or a copy of the data to be provided to the user.

Upon reading this disclosure, those of skill in the art will appreciate still additional alternative structural and functional designs through the principles disclosed herein. Therefore, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The patent claims at the end of this patent application are not intended to be construed under 35 U.S.C. § 112(f) unless traditional means-plus-function language is expressly recited, such as “means for” or “step for” language being explicitly recited in the claim(s).

What is claimed is:

1. A computer-implemented method comprising:
receiving, by one or more processors, data corresponding to a data extraction program, the data being associated with at least a first file;
executing, by the one or more processors, a confidence algorithm that causes the one or more processors to perform operations comprising:
generating a dictionary of words from one or more fields in the first file, wherein an entry in the dictionary of words corresponding to a first word in a first field of the first file includes a first confidence score associated with the first word,
determining, based at least in part on the first confidence score from the entry in the dictionary of words, a content confidence score corresponding to the first field, and
determining, based on the content confidence score and a position confidence score, a certainty score for the first field, the position confidence score being associated with a position of the first field within the first file;
determining, by the one or more processors based at least in part on the certainty score, a certainty quotient for the first file indicating a reliability of the data corresponding to the data extraction program; and
generating, by the one or more processors, a data object that indicates the certainty quotient.

2. The computer-implemented method of claim 1, wherein:
generating the dictionary of words further comprises:
determining, by the one or more processors, a span value and an offset value of the first word, wherein the entry in the dictionary of words includes (i) the span value, (ii) the offset value, and (iii) the first confidence score; and
the computer-implemented method further comprises:
generating, by the one or more processors based on span values and offset values indicated in the dictionary of words, a word confidence score array indicating respective word confidence scores for words present in the first field, and
determining, by the one or more processors based on the word confidence score array, the content confidence score.

3. The computer-implemented method of claim 1, wherein the content confidence score and the position confidence score are part of a set of confidence scores associated with the first file, and the computer-implemented method further comprises:
determining, by a certainty model, a relationship between the set of confidence scores and an extraction accuracy value indicating whether the set of confidence scores indicate accurate or inaccurate data extractions;
adjusting, by the one or more processors, coefficients included as part of the relationship until the extraction accuracy value meets or exceeds an accuracy threshold; and
determining, by the one or more processors based on the relationship, the certainty score for the first field.

4. The computer-implemented method of claim 3, wherein the certainty model is a first certainty model, and the computer-implemented method further comprises:
receiving, by one or more processors, data associated with a second file that is different from the first file;
determining, based on a second certainty model, a second relationship between confidence scores of the second file and a second extraction accuracy value, wherein the second certainty model is different from the first certainty model;
adjusting, by the one or more processors, coefficients included as part of the second relationship until the second extraction accuracy value meets or exceeds a second accuracy threshold; and
determining, based on the second relationship, a second certainty score for a field of the second file.

5. The computer-implemented method of claim 3, wherein the certainty model is a machine-learned model, the relationship corresponds to a best-fit boundary determined by the machine-learned model, and the best-fit boundary separates a portion of the set of confidence scores that indicate accurate data extractions from another portion of the set of confidence scores that indicate inaccurate data extractions.

6. The computer-implemented method of claim 3, further comprising:
generating, by the one or more processors based on the content confidence score and the position confidence score, an adjusted feature that represents interactions between the content confidence score and the position confidence score;
determining, by the one or more processors based on the adjusted feature, a normalized feature by adjusting a value of the adjusted feature to be within a normalized value range; and
determining, by the certainty model based at least in part on the normalized feature, the relationship between the set of confidence scores and the extraction accuracy value.

7. The computer-implemented method of claim 1, further comprising:
determining, by the one or more processors, that at least the certainty score causes the certainty quotient to fail to meet or exceed a certainty threshold; and
generating, by the one or more processors, the data object to indicate (i) the certainty quotient and (ii) a representation of the first field of the first file.

8. The computer-implemented method of claim 1, further comprising:
determining, by the one or more processors, the content confidence score and the position confidence score based on metadata included as part of the data corresponding to the data extraction program.

9. The computer-implemented method of claim 1, further comprising:
determining, based on the certainty quotient, a file certainty threshold for a file type associated with the first file, the file certainty threshold indicating a minimum reliability value for data extracted from files of the file type;
receiving, by the one or more processors, data associated with a second file of the file type;
determining, by the one or more processors, a second certainty quotient corresponding to the second file;
determining, by the one or more processors, whether the second certainty quotient satisfies the file certainty threshold; and
responsive to determining that the second certainty quotient fails to meet or exceed the file certainty threshold, adjusting, by the one or more processors based on the second certainty quotient, the file certainty threshold.

10. A system comprising:
one or more processors; and
at least one memory storing processor-executable instructions that, when executed by the one or more processors, cause the one or more processors to perform operations comprising:
receiving data corresponding to a data extraction program, the data being associated with at least a first file;
executing a confidence algorithm that causes the one or more processors to perform operations comprising:
generating a dictionary of words from one or more fields in the first file, wherein an entry in the dictionary of words corresponding to a first word in a first field of the first file includes a first confidence score associated with the first word,
determining, based at least in part on the first confidence score from the entry in the dictionary of words, a content confidence score corresponding to the first field, and
determining, based on the content confidence score and a position confidence score, a certainty score for the first field, the position confidence score being associated with a position of the first field within the first file;
determining, based at least in part on the certainty score, a certainty quotient for the first file indicating a reliability of the data corresponding to the data extraction program; and
generating a data object that indicates the certainty quotient.

11. The system of claim 10, wherein the processor-executable instructions, when executed by the one or more processors, further cause the one or more processors to perform operations comprising:
determining a span value and an offset value of the first word, wherein the entry in the dictionary of words includes (i) the span value, (ii) the offset value, and (iii) the first confidence score;
generating, based on span values and offset values indicated in the dictionary of words, a word confidence score array indicating respective word confidence scores for words present in the first field; and
determining, based on the word confidence score array, the content confidence score.

12. The system of claim 10, wherein the content confidence score and the position confidence score are part of a set of confidence scores associated with the first file, and the processor-executable instructions, when executed by the one or more processors, further cause the one or more processors to perform operations comprising:
determining, by a certainty model, a relationship between the set of confidence scores and an extraction accuracy value indicating whether the set of confidence scores indicate accurate or inaccurate data extractions;
adjusting coefficients included as part of the relationship until the extraction accuracy value meets or exceeds an accuracy threshold; and
determining, based on the relationship, the certainty score for the first field.

13. The system of claim 12, wherein the certainty model is a first certainty model, and the processor-executable instructions, when executed by the one or more processors, further cause the one or more processors to perform operations comprising:
receiving data associated with a second file that is different from the first file;
determining, based on a second certainty model, a second relationship between confidence scores of the second file and a second extraction accuracy value, wherein the second certainty model is different from the first certainty model;
adjusting coefficients included as part of the second relationship until the second extraction accuracy value meets or exceeds a second accuracy threshold; and
determining, based on the second relationship, a second certainty score for a field of the second file.

14. The system of claim 12, wherein the certainty model is a machine-learned model, the relationship corresponds to a best-fit boundary determined by the machine-learned model, and the best-fit boundary separates a portion of the set of confidence scores that indicate accurate data extractions from another portion of the set of confidence scores that indicate inaccurate data extractions.

15. The system of claim 12, wherein the processor-executable instructions, when executed by the one or more processors, further cause the one or more processors to perform operations comprising:
generating, based on the content confidence score and the position confidence score, an adjusted feature that represents interactions between the content confidence score and the position confidence score;
determining, based on the adjusted feature, a normalized feature by adjusting a value of the adjusted feature to be within a normalized value range; and
determining, based at least in part on the normalized feature, the relationship between the set of confidence scores and the extraction accuracy value.

16. The system of claim 10, wherein the processor-executable instructions, when executed by the one or more processors, further cause the one or more processors to perform operations comprising:
determining that at least the certainty score causes the certainty quotient to fail to meet or exceed a certainty threshold; and
generating the data object to indicate (i) the certainty quotient and (ii) a representation of the first field of the first file.

17. The system of claim 10, wherein the processor-executable instructions, when executed by the one or more processors, further cause the one or more processors to perform operations comprising:
determining the content confidence score and the position confidence score based on metadata included as part of the data corresponding to the data extraction program.

18. The system of claim 10, wherein the processor-executable instructions, when executed by the one or more processors, further cause the one or more processors to perform operations comprising:
determining, based on the certainty quotient, a file certainty threshold for a file type associated with the first file, the file certainty threshold indicating a minimum reliability value for data extracted from files of the file type;
receiving data associated with a second file of the file type;
determining a second certainty quotient corresponding to the second file;
determining whether the second certainty quotient satisfies the file certainty threshold; and
responsive to determining that the second certainty quotient fails to meet or exceed the file certainty threshold, adjusting, based on the second certainty quotient, the file certainty threshold.

19. One or more non-transitory computer-readable media storing processor-executable instructions that, when executed by one or more processors, cause the one or more processors to perform operations comprising:
receiving data corresponding to a data extraction program, the data being associated with at least a first file;
executing a confidence algorithm that comprises:
generating a dictionary of words from one or more fields in the first file, wherein an entry in the dictionary of words corresponding to a first word in a first field of the first file includes a first confidence score associated with the first word,
determining, based at least in part on the first confidence score from the entry in the dictionary of words, a content confidence score corresponding to the first field, and
determining, based on the content confidence score and a position confidence score, a certainty score for the first field, the position confidence score being associated with a position of the first field within the first file;
determining, based at least in part on the certainty score, a certainty quotient for the first file indicating a reliability of the data corresponding to the data extraction program; and
generating a data object that indicates the certainty quotient.

20. The one or more non-transitory computer-readable media of claim 19, wherein the processor-executable instructions, when executed by the one or more processors, further cause the one or more processors to perform operations comprising:
determining a span value and an offset value of the first word, wherein the entry in the dictionary of words includes (i) the span value, (ii) the offset value, and (iii) the first confidence score;
generating, based on span values and offset values indicated in the dictionary of words, a word confidence score array indicating respective word confidence scores for words present in the first field; and
determining, based on the word confidence score array, the content confidence score.
